(19) United States
(12) Patent Application Publication
(10) Pub. No.: US 2024/0088452 A1
(43) Pub. Date: Mar. 14, 2024

(54) CATALYTIC SOLUTION FOR HALIDE ION BATTERY

(71) Applicant: AISIN CORPORATION, Kariya, Aichi (JP)

(72) Inventors: Toru JOBOJI, Kariya-shi (JP); Katsuhiko SAGUCHI, Kariya-shi (JP); Norifumi HASEGAWA, Kariya-shi (JP)

(73) Assignee: AISIN CORPORATION, Kariya, Aichi (JP)

(21) Appl. No.: 18/269,900

(22) PCT Filed: Mar. 4, 2022
(86) PCT No.: PCT/JP2022/009546

§ 371 Date: Jun. 27, 2023

(30) Foreign Application Priority Data
Mar. 4, 2021 (JP) 2021-034413

(51) Int. Cl. H01M 10/36; H01M 6/04

(52) U.S. Cl. CPC H01M 10/36; H01M 6/045; H01M 2300/0002

(57) ABSTRACT

A catalytic solution for a halide ion battery, which is an aqueous solution containing a quaternary ammonium halide salt or a hydrate thereof at 9.0 mol/kg to 11.0 mol/kg, is an electrolyte for a halide ion battery that has excellent safety and a wide potential window.

### TECHNICAL FIELD

This disclosure relates to a catalytic solution for a halide ion battery.

### BACKGROUND ART

A halide ion battery that performs charging and discharging by a mechanism of shuttling halide ions to a metal active material has attracted attention as one of post lithium ion batteries, and particularly, it is expected to develop a halide ion battery having a particularly excellent volume energy density, which is not possessed by existing batteries. Among halide ions, particularly, a fluoride ion has the smallest size among anions and is useful for charge transport, and therefore, a fluoride ion battery has particularly attracted attention.

Among halide ion batteries, many fluoride ion batteries known in the related art have been reported, which operate at a high temperature using an ionic liquid, an organic electrolytic solution, or a solid electrolyte.

Therefore, a halide ion battery that can enable charge and discharge of the halide ion battery at a lower temperature has been studied.

For example, NPL 1 reports a room temperature-operating fluoride ion battery using an electrolyte composed of an ether solution of a tetraalkylammonium fluoride.

In addition, NPL 2 reports an aqueous fluoride ion battery using 0.8 mol/L NaF for an electrolyte. NPL 2 is considered to be the first report indicating that the fluoride ion battery operates in an aqueous solution.

### CITATION LIST

### Non Patent Literature

NPL 1: Science. 362, 1144-1148 (2018)
NPL 2: J. Electrochem. Soc., 166, A2419-A2424 (2019)

### SUMMARY OF DISCLOSURE

### Technical Problem

However, in NPL 1, since a solubility of the tetraalkylammonium fluoride in various organic solvents is about 2.3 mol/L at maximum, a pH is 8 or less. In addition, in NPL 2, since a concentration of NaF is 0.8 mol/L, a pH is less than 7. Therefore, in both NPLs 1 and 2, there is a possibility that free hydrogen fluoride is generated as a reaction intermediate, and there is a concern about safety.

In addition, in NPL 1, since an ether-based electrolyte is used, the electrolyte has high inflammability and there is a concern about safety.

In addition, in NPL 2, since NaF is used, a potential window is as narrow as 1.4 V, and thus a halide ion battery having a high capacity cannot be expected.

This disclosure has been made to solve the above problem, and an object of this disclosure is to provide an electrolyte for a halide ion battery having excellent safety and a wide potential window.

### Solution to Problem

The present inventors have conducted intensive studies to achieve the above object. As a result, the present inventors have found that a concentrated aqueous solution of a quaternary alkylammonium halide salt becomes a strong base due to a change in a state of water contained in the aqueous solution, and therefore, hydrogen fluoride is not generated, and a potential window thereof is significantly enlarged as compared with a case of a dilute aqueous solution. The concentrated aqueous solution of the quaternary alkylammonium halide salt can be produced unexpectedly by dropping a small amount of water to the quaternary alkylammonium halide salt. This disclosure is completed as a result of further research based on these findings. That is, this disclosure includes the following configurations.

Item 1. A catalytic solution for a halide ion battery, which is an aqueous solution containing a quaternary ammonium halide salt or a hydrate thereof at 9.0 mol/kg to 11.0 mol/kg.

Item 2. The catalytic solution for a halide ion battery according to item 1, in which the quaternary ammonium halide salt or the hydrate thereof contained in the aqueous solution is only one kind.

Item 3. The catalytic solution for a halide ion battery according to item 1 or 2, in which the quaternary ammonium halide salt or the hydrate thereof is a quaternary ammonium fluoride salt or a hydrate thereof.

Item 4. The catalytic solution for a halide ion battery according to any one of items 1 to 3, which is an electrolytic solution for a fluoride ion battery.

Item 5. A halide ion battery containing: the catalytic solution for a halide ion battery according to any one of items 1 to 4.

Item 6. The halide ion battery according to item 5, which is a fluoride ion battery.

Item 7. A method for producing the catalytic solution for a halide ion battery according to any one of items 1 to 4, including:
a step of dropping water to the quaternary ammonium halide salt or the hydrate thereof, in which
an amount of the water dropped is 13 to 30 parts by mass with respect to 100 parts by mass of the quaternary ammonium halide salt or the hydrate thereof.

### Advantageous Effects of Disclosure

According to this disclosure, an electrolyte for a halide ion battery having excellent safety and a wide potential window can be provided.

### BRIEF DESCRIPTION OF DRAWINGS

FIG. 1 is a graph showing a result of potential window measurement according to Test Example 1 (cyclic voltammetry using aqueous solutions in Examples 1 and 2 and Comparative Examples 1 and 2).

FIG. 2 is a graph showing a result of potential window measurement according to Test Example 1 (cyclic voltammetry using aqueous solutions having different molar concentrations of a tetraethylammonium fluoride salt).

FIG. 3 is a graph showing a result of Test Example 2 (a relation between a concentration and a pH of an aqueous solution in aqueous solutions having different molar concentrations of a tetraethylammonium fluoride salt).

FIG. 4 is a graph showing a result of Test Example 2 (a relation between a concentration and a pH of an aqueous solution in aqueous solutions having different molar concentrations of a tetrabutylammonium fluoride salt).

FIG. 5 is a graph showing a result of Test Example 3 (a charge and discharge curve of a half cell in a case where a positive electrode active material and a negative electrode active material using the aqueous solution in Example 1 are Cu or CuF₂).

FIG. 6 shows an overview of a three-electrode electrolytic cell produced by a method in Production Example 1 after performing two cycles of a charge and discharge test using the aqueous solutions obtained in Example 1 and Comparative Example 1.

### DESCRIPTION OF EMBODIMENTS

In the present description, “contain” is a concept that includes all of “comprise”, “consist essentially of”, and “consist of”.

In addition, in the present description, when a numerical range is indicated by “A to B”, it means A or more and B or less.

In addition, in the present description, a halide ion battery means a battery that can operate using a halide ion as a charge carrier, and includes both a halide ion primary battery and a halide ion secondary battery.

In addition, in the present description, a fluoride ion battery means a battery that can operate using a fluoride ion as a charge carrier, and includes both a fluoride ion primary battery and a fluoride ion secondary battery.

1. Catalytic Solution for Halide Ion Battery

A catalytic solution for a halide ion battery disclosed here is an aqueous solution containing a quaternary ammonium halide salt or a hydrate thereof at 9.0 mol/kg to 11.0 mol/kg.

The quaternary ammonium halide salt is not particularly limited, and examples thereof include a quaternary ammonium halide salt represented by a general formula (1):

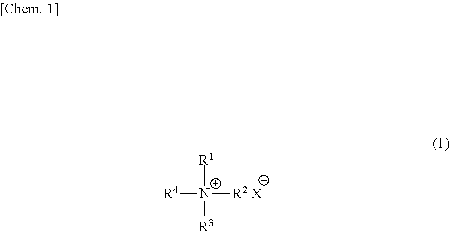

[In the formula, R¹, R², R³, and R⁴ are the same as or different from each other and each represent an alkyl group or an aryl group. X represents a halogen atom.]

In the general formula (1), the alkyl group represented by R¹, R², R³, and R⁴ can be any of a linear alkyl group and a branched alkyl group, and examples thereof include an alkyl group having 1 to 30 carbon atoms (particularly an alkyl group having 1 to 20 carbon atoms) such as a methyl group, an ethyl group, an n-propyl group, an isopropyl group, an n-butyl group, an isobutyl group, a sec-butyl group, and a tert-butyl group. Among them, from a viewpoint of safety, a potential window, and a capacity after the halide ion battery is produced, a linear alkyl group is preferable, a linear alkyl group having 1 to 30 carbon atoms is more preferable, a linear alkyl group having 1 to 20 carbon atoms is still more preferable, and an ethyl group or an n-butyl group is particularly preferable.

Examples of the aryl group represented by R¹, R², R³, and R⁴ in the general formula (1) include a phenyl group, a naphthyl group, an anthracenyl group, a phenanthryl group, and a biphenyl group. Among them, a phenyl group is preferable from a viewpoint of safety, a potential window, and a capacity after the halide ion battery is produced.

In the general formula (1), examples of the halogen atom represented by X include a fluorine atom, a chlorine atom, a bromine atom, and an iodine atom. These halogen atoms are preferably selected in accordance with a charge carrier in the halide ion battery disclosed here.

Among them, a fluorine atom is preferable because the fluorine atom has the smallest size among anions and is useful for charge transport. That is, the quaternary ammonium halide salt is preferably a quaternary alkylammonium fluoride salt.

Specifically, examples of the quaternary ammonium halide salt satisfying the above conditions include

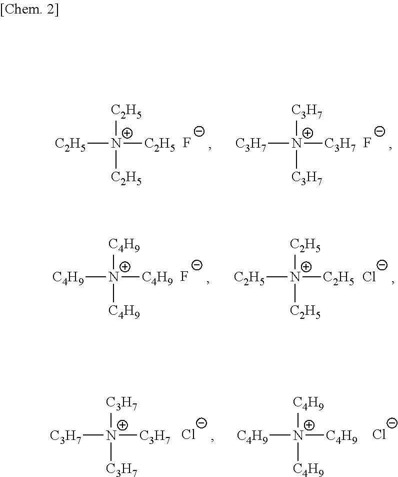

or the like.

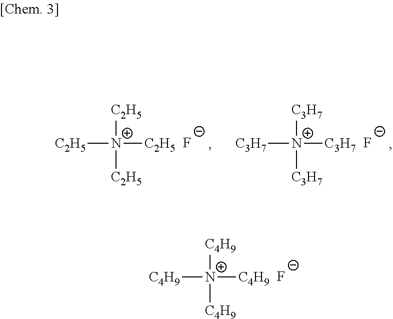

or the like is preferable.

The above quaternary ammonium halide salt may be a hydrate.

These quaternary ammonium halide salts or hydrates thereof may be contained alone or in a plurality kinds thereof in the catalytic solution for a halide ion battery disclosed here. However, it is known that in a lithium ion secondary battery, when a plurality of lithium salts are mixed, a potential window is further widened by co-crystallization, but in the quaternary ammonium halide salt or the hydrate thereof, even when a plurality of the above quaternary ammonium halide salts or hydrates thereof are mixed, the quaternary ammonium halide salts or the hydrates thereof are not co-crystallized and are separated into a plurality of phases. Therefore, from the viewpoint of a potential window and a capacity after the halide ion battery is produced, it is preferable to contain the above quaternary ammonium halide salt or hydrate thereof alone (only one kind).

A concentration of the quaternary ammonium halide salt or the hydrate thereof contained in the catalytic solution for a halide ion battery disclosed here is 9.0 mol/kg to 11.0 mol/kg, preferably 9.2 mol/kg to 11.0 mol/kg, and more preferably 9.5 mol/kg to 10.9 mol/kg. When the concentration of the quaternary ammonium halide salt or the hydrate thereof is less than 9.0 mol/kg, there is a possibility that free hydrogen fluoride is generated as a reaction intermediate due to a low pH, there is a concern about safety, and a halide ion battery having a narrow potential window and a high capacity cannot be obtained. On the other hand, it is difficult to produce an aqueous solution in which the concentration of the quaternary ammonium halide salt or the hydrate thereof is higher than 11.0 mol/kg.

It does not exclude that the catalytic solution for a halide ion battery disclosed here contains not only the above quaternary ammonium halide salt or hydrate thereof, but also an electrolyte that can be used for a halide ion battery in the related art, for example, an alkali metal fluoride such as lithium fluoride, sodium fluoride, potassium fluoride, rubidium fluoride, or cesium fluoride; and an alkali metal sulfonylamide salt such as lithium bistrifluoromethane sulfonylamide, sodium bistrifluoromethane sulfonylamide, potassium bistrifluoromethane sulfonylamide, rubidium bistrifluoromethane sulfonylamide, or cesium bistrifluoromethane sulfonylamide. However, from the viewpoint of the safety, a potential window, a capacity after the halide ion battery is produced, a content of these electrolytes in the related art is preferably as small as possible, and for example, is preferably 0 mol/kg to 1 mol/kg, and more preferably 0 mol/kg to 0.1 mol/kg.

The catalytic solution for a halide ion battery disclosed here is not particularly limited, and is preferably strongly basic from a viewpoint that even during charge and discharge of the halide ion battery, free hydrogen fluoride as a reaction intermediate is hardly generated, the potential window is easily widened, and the capacity after the halide ion battery is produced is easily improved. Specifically, a pH of the catalytic solution for a halide ion battery disclosed here is preferably 8 to 14, more preferably 10 to 14, and still more preferably 12 to 14.

The catalytic solution for a halide ion battery disclosed here as described above is useful as various catalytic solutions such as a catalytic solution for a halide ion battery, for example, an electrolytic solution for a fluoride ion battery because the catalytic solution for a halide ion battery is excellent in safety and has a wide potential window since free hydrogen fluoride as a reaction intermediate is not generated and it is difficult to ignite. Particularly, when the catalytic solution for a halide ion battery disclosed here as described above is used as the catalytic solution for a halide ion battery such as the electrolytic solution for a fluoride ion battery, it is possible to produce a halide ion battery having a high capacity (particularly, a fluoride ion battery having a high capacity) because the catalytic solution for a halide ion battery is excellent in safety and has a wide potential window since free hydrogen fluoride as a reaction intermediate is not generated and it is difficult to ignite.

2. Halide Ion Battery

A halide ion battery disclosed here (particularly, a fluoride ion battery) is not particularly limited as long as it contains the above catalytic solution for a halide ion battery disclosed here (particularly, an electrolytic solution for a fluoride ion battery).

The halide ion battery disclosed here (particularly, the fluoride ion battery) can include: for example,
a positive electrode active material layer;
a negative electrode active material layer;
an electrolytic solution layer formed between the positive electrode active material layer and the negative electrode active material layer and containing the above catalytic solution for a halide ion battery disclosed here;
a positive electrode current collector that collects a current from the positive electrode active material layer;
a negative electrode current collector that collects a current from the negative electrode active material layer; and
a battery case that houses the members.

Hereinafter, the halide ion battery disclosed here (particularly, the fluoride ion battery) will be described for each configuration.

(2-1) Electrolyte Layer

An electrolyte layer in the halide ion battery disclosed here (particularly, the fluoride ion battery) can be formed between the positive electrode active material layer and the negative electrode active material layer. In the halide ion battery disclosed here (particularly, the fluoride ion battery), the electrolyte layer contains the above catalytic solution for a halide ion battery disclosed here. A thickness of the electrolyte layer varies greatly depending on a configuration of a battery, and is not particularly limited, and can be appropriately set depending on an application according to a general method.

(2-2) Positive Electrode Active Material Layer

The positive electrode active material layer in the halide ion battery disclosed here (particularly, the fluoride ion battery) can contain at least a positive electrode active material. In addition, the positive electrode active material layer can further contain at least one of a conductive material and a binder other than the positive electrode active material.

In general, the positive electrode active material used in the halide ion battery disclosed here (particularly, the fluoride ion battery) can contain an active material that is dehalogenated (particularly, defluorinated) during discharge.

Examples of the positive electrode active material include a metal simple substance, an alloy, a metal oxide, and a halide thereof (particularly, a fluoride). Examples of a metal element contained in the positive electrode active material include copper, silver, nickel, cobalt, lead, cerium, manganese, gold, platinum, rhodium, vanadium, osmium, ruthenium, iron, chromium, bismuth, niobium, antimony, titanium, tin, and zinc. Among them, the positive electrode active material is preferably Cu, CuFₓ, CuClₓ, Fe, FeFₓ, FeClₓ, Ag, AgFₓ, AgClₓ, or the like. The above x is a real number larger than 0.

In addition, other examples of the positive electrode active material include a carbon material and a fluoride thereof. Examples of the carbon material include graphite, coke, and a carbon nanotube.

In addition, further other examples of the positive electrode active material include a polymer material. Examples of the polymer material include polyaniline, polypyrrole, polyacetylene and polythiophene.

These positive electrode active materials can be used alone or in combination of two or more thereof.

The conductive material is not particularly limited as long as it has desired electronic conductivity, and examples thereof include a carbon material.

Examples of the carbon material include carbon black such as acetylene black, Ketjen black, furnace black, and thermal black.

On the other hand, the binder is not particularly limited as long as it is chemically and electrically stable, and examples thereof include a fluorine-based binder such as polyvinylidene fluoride (PVDF) and polytetrafluoroethylene (PTFE).

In addition, a content of the positive electrode active material in the positive electrode active material layer is preferably larger from the viewpoint of a capacity, and can be appropriately set depending on an application according to a general method. In addition, a thickness of the positive electrode active material layer varies greatly depending on a configuration of a battery, and is not particularly limited, and can be appropriately set depending on an application according to a general method.

(2-3) Negative Electrode Active Material Layer

The negative electrode active material layer in the halide ion battery disclosed here (particularly, the fluoride ion battery) can contain at least a negative electrode active material. In addition, the negative electrode active material layer can further contain at least one of a conductive material and a binder other than the negative electrode active material.

In general, the negative electrode active material used in the halide ion battery disclosed here (particularly, the fluoride ion battery) can contain an active material that is halogenated (particularly, fluorinated) during discharge. In addition, an optional active material having a potential lower than that of the positive electrode active material may be selected for the negative electrode active material. Therefore, the above positive electrode active material can be used as the negative electrode active material.

Examples of the negative electrode active material include a metal simple substance, an alloy, a metal oxide, and a halide thereof (particularly, the fluoride). Examples of a metal element contained in the negative electrode active material include lanthanum, calcium, aluminum, europium, lithium, silicon, germanium, tin, indium, vanadium, cadmium, chromium, iron, zinc, gallium, titanium, niobium, manganese, ytterbium, zirconium, samarium, cerium, magnesium, barium, and lead. Among them, the negative electrode active material is preferably Mg, MgFₓ, MgClₓ, Al, AlFₓ, AlClₓ, Ce, CeFₓ, CeClₓ, La, LaFₓ, LaClₓ, Ca, CaFₓ, CaClₓ, Pb, PbFₓ, PbClₓ, or the like. The above x is a real number larger than 0. In addition, the above carbon material and polymer material can be used as the negative electrode active material.

The same material as the material described in the above positive electrode active material layer can be used for the conductive material and the binder. In addition, a content of the negative electrode active material in the negative electrode active material layer is preferably larger from the viewpoint of the capacity, and can be appropriately set depending on an application according to a general method. In addition, a thickness of the negative electrode active material layer varies greatly depending on a configuration of a battery, and is not particularly limited, and can be appropriately set depending on an application according to a general method.

(2-4) Other Configurations

The halide ion battery disclosed here (particularly, the fluoride ion battery) preferably includes at least the above negative electrode active material layer, positive electrode active material layer, and electrolyte layer. Further, the halide ion battery usually includes a positive electrode current collector that collects a current from the positive electrode active material layer, and a negative electrode current collector that collects a current from the negative electrode active material layer. Examples of a shape of a current collector include a foil shape, a mesh shape, or a porous shape. In addition, the halide ion battery disclosed here (particularly, the fluoride ion battery) may include a separator between the positive electrode active material layer and the negative electrode active material layer. Accordingly, a battery having higher safety can be obtained.

(2-5) Halide Ion Battery (Fluoride Ion Battery)

The halide ion battery disclosed here (particularly, the fluoride ion battery) is not particularly limited as long as it includes the above positive electrode active material layer, negative electrode active material layer, and electrolyte layer. In addition, the halide ion battery disclosed here (particularly, the fluoride ion battery) may be a halide ion primary battery (particularly, a fluoride ion primary battery) or a halide ion secondary battery (particularly, a fluoride ion secondary battery), and is preferably a halide ion secondary battery (particularly, a fluoride ion secondary battery). The halide ion battery can be repeatedly charged and discharged, and is useful as, for example, a regenerated energy storage battery, an in-vehicle battery, or a smart house battery. In addition, examples of a shape of the halide ion battery disclosed here (particularly, the fluoride ion battery) include a coin shape, a laminate shape, a cylindrical shape, and a square shape.

3. Method for Producing Catalytic Solution for Halide Ion Battery

The above catalytic solution for a halide ion battery disclosed here is not particularly limited in a production method, and can be produced by a method including:
a step of dropping water to the quaternary ammonium halide salt or the hydrate thereof, in which
an amount of the water dropped is 13 to 30 parts by mass with respect to 100 parts by mass of the quaternary ammonium halide salt or the hydrate thereof.

Since a solubility of the quaternary ammonium halide salt in water at room temperature (25° C.) is about 2.3 mol/kg at maximum, a 9.0 mol/kg to 11.0 mol/kg concentrated aqueous solution cannot be obtained even when the quaternary ammonium halide salt is added to water to be dissolved.

However, when a small amount of water is dropped to the quaternary ammonium halide salt or the hydrate thereof, unexpectedly, a concentrated aqueous solution containing the quaternary ammonium halide salt or the hydrate thereof at 9.0 mol/kg to 11.0 mol/kg can be obtained.

In addition, when the quaternary ammonium halide salt or the hydrate thereof is dissolved in water to obtain a dilute aqueous solution, the potential window at room temperature (25° C.) is only about 1.5 V. In comparison with this case, when the concentrated aqueous solution containing the quaternary ammonium halide salt or the hydrate thereof is obtained in this manner, the potential window at room temperature (25° C.) can be expanded to be about 3.0 V.

Further, when the quaternary ammonium halide salt or the hydrate thereof is dissolved in water to obtain the dilute aqueous solution, the aqueous solution is in a neutral region at room temperature, there is a risk that free hydrogen fluoride as a reaction intermediate is generated, and there is a concern about safety. In comparison with this case, when the concentrated aqueous solution containing the quaternary ammonium halide salt or the hydrate thereof is obtained in this manner, the quaternary ammonium halide salt or the hydrate thereof itself does not have a hydroxide ion, a state of water is changed, a strong base is obtained, and free hydrogen fluoride as a reaction intermediate cannot be generated, so that the safety can also be dramatically improved.

In this way, when water is dropped to the quaternary ammonium halide salt or the hydrate thereof, an amount of the water dropped is 13 to 30 parts by mass, preferably 14 to 27 parts by mass, and more preferably 15 to 25 parts by mass with respect to 100 parts by mass of the quaternary ammonium halide salt or the hydrate thereof. When the amount of the water dropped is less than 5 parts by mass, the quaternary ammonium halide salt or the hydrate thereof cannot be sufficiently dissolved in water, and cannot function as the catalytic solution for a halide ion battery. On the other hand, when the amount of the water dropped is more than 50 parts by mass, the concentration of the quaternary ammonium halide salt or the hydrate thereof becomes low, and the potential window at room temperature (25° C.) cannot be sufficiently widened, so that there is a risk that the pH becomes low, free hydrogen fluoride as a reaction intermediate is generated, and there is a concern about safety.

When water is dropped to the quaternary ammonium halide salt or the hydrate thereof, a temperature at this time is not particularly limited, and may be generally around room temperature, and for example, is preferably 20° C. to 50° C., and more preferably 22° C. to 30° C.

An example of the method for producing the catalytic solution for a halide ion battery disclosed here is described above, but the method for producing the catalytic solution for a halide ion battery disclosed here is not limited to the above. For example, the catalytic solution for a halide ion battery can also be obtained by dehydration from a dilute aqueous solution containing the quaternary ammonium halide salt or the hydrate thereof.

This disclosure is not limited to the above embodiment. The above embodiment is an example, and any configuration having substantially the same configuration as the technical idea described in the scope of the claims of this disclosure and having the same effect and function is included in the technical scope of the present disclosure.

### EXAMPLES

Hereinafter, this disclosure will be described in detail based on Examples. However, the following Examples do not limit this disclosure.

In Examples, the following compounds were used as a quaternary alkylammonium halide salt or a hydrate thereof.

Tetraethylammonium fluoride salt (TEAF salt): manufactured by Tokyo Chemical Industry Co., Ltd. (a molar concentration calculated based on a water concentration by a Karl Fischer's method is 19.1 mol/kg; a water content is 2.9 mol relative to 1 mol of salt)

Tetrabutylammonium fluoride salt (TBAF salt): manufactured by Tokyo Chemical Industry Co., Ltd. (a molar concentration calculated based on a water concentration by a Karl Fischer's method is 21.7 mol/kg; a water content is 2.6 mol relative to 1 mol of salt).

### Example 1: TEAF Concentrated Aqueous Solution

Under an atmospheric atmosphere, 15 parts by mass of water was dropped to 100 parts by mass of the tetraethylammonium fluoride salt (TEAF salt) at room temperature (25° C.). As a result, a concentrated aqueous solution of the tetraethylammonium fluoride salt (TEAF salt) (a TEAF concentrated aqueous solution) was obtained. The obtained TEAF concentrated aqueous solution had a molar concentration of 10.0 mol/kg calculated based a water concentration of the tetraethylammonium fluoride salt (TEAF salt) by the Karl Fischer's method, and contained 5.5 mol of water per mol of the salt. That is, it can be understood that when the TEAF concentrated aqueous solution is used as the catalytic solution for a halide ion battery, free hydrogen fluoride is not generated, and thus safety is excellent.

### Example 2: TBAF Concentrated Aqueous Solution

Under an atmospheric atmosphere, 21 parts by mass of water was dropped to 100 parts by mass of the tetrabutylammonium fluoride salt (TBAF salt) at room temperature (25° C.). As a result, a concentrated aqueous solution of the tetrabutylammonium fluoride salt (TBAF salt) (a TBAF concentrated aqueous solution) was obtained. The obtained TBAF concentrated aqueous solution had a molar concentration of 10.9 mol/kg calculated based on a water concentration of the tetrabutylammonium fluoride salt (TBAF salt) by the Karl Fischer's method, and contained 5.1 mol of water per mol of the salt. That is, it can be understood that when the TBAF concentrated aqueous solution is used as the catalytic solution for a halide ion battery, free hydrogen fluoride is not generated, and thus safety is excellent.

### Comparative Example 1: TEAF Dilute Aqueous Solution

Under an atmospheric atmosphere, 100 parts by mass of the tetraethylammonium fluoride salt (TEAF salt) was dissolved in 670 parts by mass of water at room temperature (25° C.) to obtain a dilute aqueous solution of the tetraethylammonium fluoride salt (TEAF salt) (a TEAF dilute aqueous solution). The obtained TEAF dilute aqueous solution had a molar concentration of 1.0 mol/kg calculated based on a water concentration of the tetraethylammonium fluoride salt (TEAF salt) by the Karl Fischer's method, and contained 55.5 mol of water per mol of the salt.

### Comparative Example 2: TBAF Dilute Aqueous Solution

Under an atmospheric atmosphere, 100 parts by mass of the tetrabutylammonium fluoride salt (TBAF salt) was dissolved in 380 parts by mass of water at room temperature (25° C.) to obtain a dilute aqueous solution of the tetrabutylammonium fluoride salt (TBAF salt) (a TBAF dilute aqueous solution). The obtained TBAF dilute aqueous solution had a molar concentration of 1.0 mol/kg calculated based on a water concentration of the tetrabutylammonium fluoride salt (TBAF salt) by the Karl Fischer's method, and contained 55.5 mol of water per mol of the salt.

### Test Example 1: Measurement of Potential Window

A glassy carbon electrode (manufactured by EC Frontier Co., Ltd.) having a diameter of 3 mm as a working electrode (positive electrode), a platinum wire as a counter electrode, and a silver/silver chloride electrode as a reference electrode were immersed in the aqueous solution obtained in each of Examples 1 and 2 and Comparative Examples 1 to 5 to produce a potential window measuring cell (fluoride ion secondary battery).

A potential window of the produced potential window measuring cell was determined by sweeping a potential of the working electrode at a constant rate (sweep rate: 0.5 mV/sec) with respect to the counter electrode at a measurement temperature that is room temperature (25° C.) using a potentiostat (manufactured by Hokuto Denko Corporation) to measure a current (LSV measurement), and setting a potential when reaching a constant value (20 μA/cm²) as an ultimate oxidation-reduction potential.

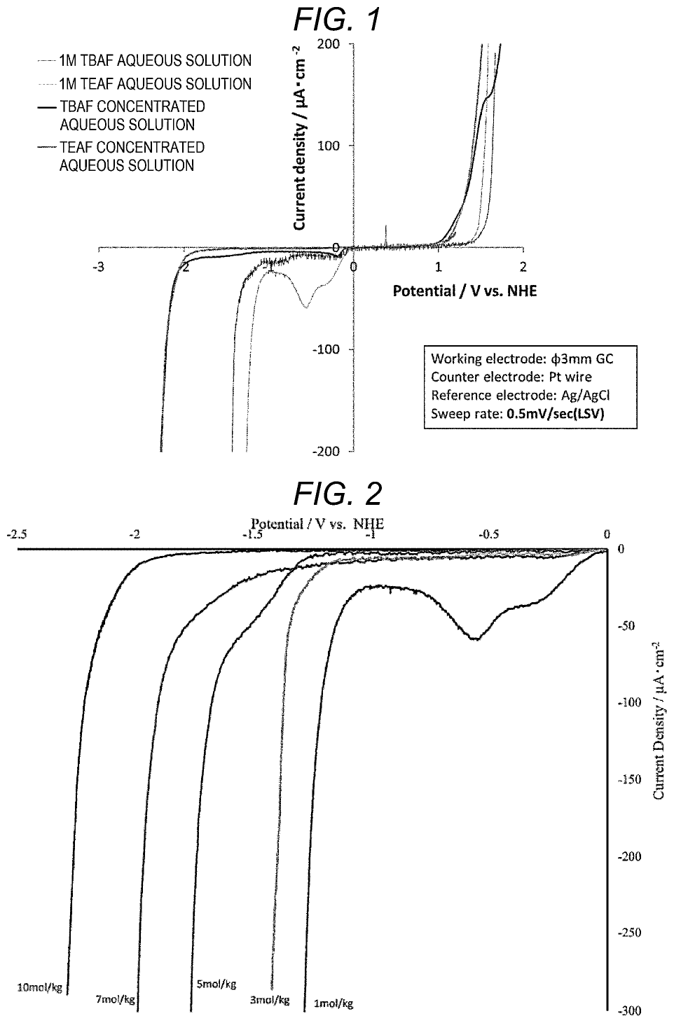

The result is shown in FIG. 1. As a result, as shown in FIG. 1, the potential window was 1.5 V to 2.5 V in the dilute aqueous solution in Comparative Examples 1 and 2, whereas the potential window was significantly widened to 3.2 V to 3.3 V in the concentrated aqueous solution in Examples 1 and 2.

In addition, in Example 1, the amount of water dropped was appropriately adjusted to produce aqueous solutions having different molar concentrations (1.0 ml/kg, 3.0 ml/kg, 5.0 ml/kg, 7.0 ml/kg, and 10.0 ml/kg) of the tetraethylammonium fluoride salt (TEAF salt). Similarly, the measurement result is shown in FIG. 2. In the aqueous solutions in Comparative Examples 1 and 3 to 5, a potential at which a current density rose was about −1.2 V in Comparative Example 1, about −1.4 V in Comparative Examples 3 and 4, and about −1.5 V in Comparative Example 5, and an absolute value thereof was not sufficiently large, whereas in the concentrated aqueous solution in Example 1, a potential at which a current density rose was about −2.1 V, and an absolute value thereof was sufficiently large.

### Test Example 2: Relation Between Concentration and pH of Aqueous Solution

In Examples 1 and 2, the amount of water dropped was appropriately adjusted to produce aqueous solutions having different molar concentrations of the tetrabutylammonium fluoride salt (TBAF salt). Then, the pH of each of the obtained aqueous solutions was measured, and a relation between the concentration and the pH of each of the aqueous solutions was evaluated.

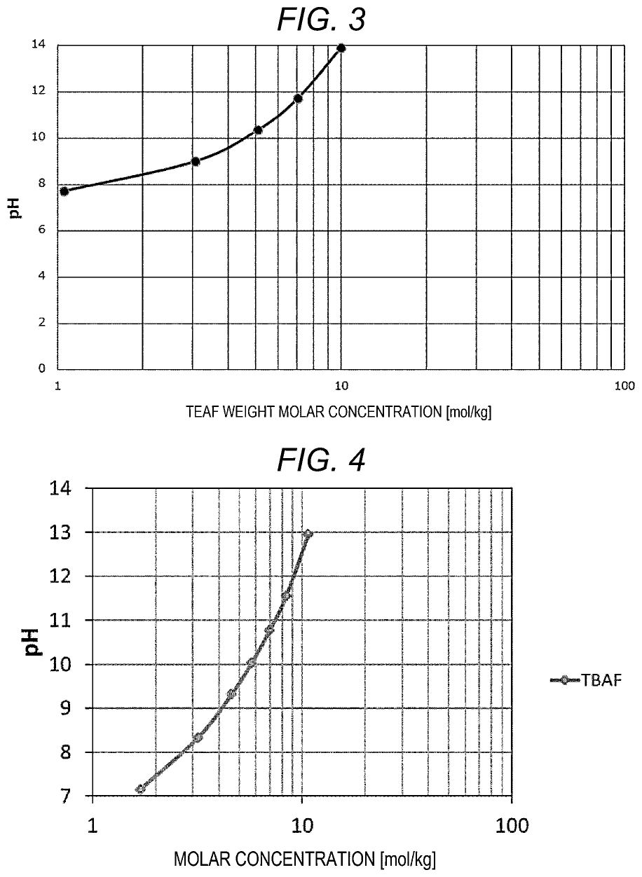

Results are shown in FIGS. 3 and 4. As a result, although the tetraethylammonium fluoride salt (TEAF salt) and the tetrabutylammonium fluoride salt (TBAF salt) did not contain hydroxide ions, the pH increased as the molar concentrations of the tetraethylammonium fluoride salt (TEAF salt) and the tetrabutylammonium fluoride salt (TBAF salt) increased.

### Production Example 1: Three-electrode Electrolytic Cell

In a charge and discharge test to be described later, an electrochemical measurement VC-4 voltammetry cell (fluoride ion secondary battery) manufactured by BAS Inc., i.e., a three-electrode electrolytic cell, was assembled and tested as follows.

Copper nanoparticles having an average particle size of 100 nm or a copper fluoride (CuF₂) reagent was used as the positive electrode active material.

Thereafter, the above positive electrode active material, acetylene black, and a polytetrafluoroethylene powder were mixed such that a content of the positive electrode active material was 85% by mass, a content of the acetylene black was 10% by mass, and a content of the polytetrafluoroethylene powder was 5% by mass. The obtained mixture was molded to a diameter of 8 mm using a punch to obtain a positive electrode.

Next, a titanium mesh (100 mesh) having a size larger than that of the positive electrode was used as the positive electrode current collector, and the obtained positive electrode was stacked thereon, followed by immersion in each of the aqueous solutions (electrolytic solutions) obtained in Examples 1 and 2 and Comparative Examples 1 and 2.

In addition, in the same manner as the above positive electrodes and positive electrode current collector, a negative electrode and a negative electrode current collector were also produced, the negative electrode was placed on the negative electrode current collector, followed by immersion in each of the aqueous solutions (electrolytic solutions) obtained in Examples 1 and 2 and Comparative Examples 1 and 2.

As the reference electrode, a silver/silver chloride electrode was used, followed by immersion in each of the aqueous solutions (electrolytic solutions) obtained in Examples 1 and 2 and Comparative Examples 1 and 2.

### Test Example 3: Charge and Discharge Test

Using the aqueous solution obtained in Example 1, a charge and discharge test was performed using the three-electrode electrolytic cell produced by the method in Production Example 1.

With respect to charge and discharge conditions, the potential was set as −1.0 V to +0.6 V, a charge or discharge rate was set as 0.02 C in both a charge mode and a discharge mode, and a measurement temperature was room temperature (30° C.) for the silver/silver chloride electrode.

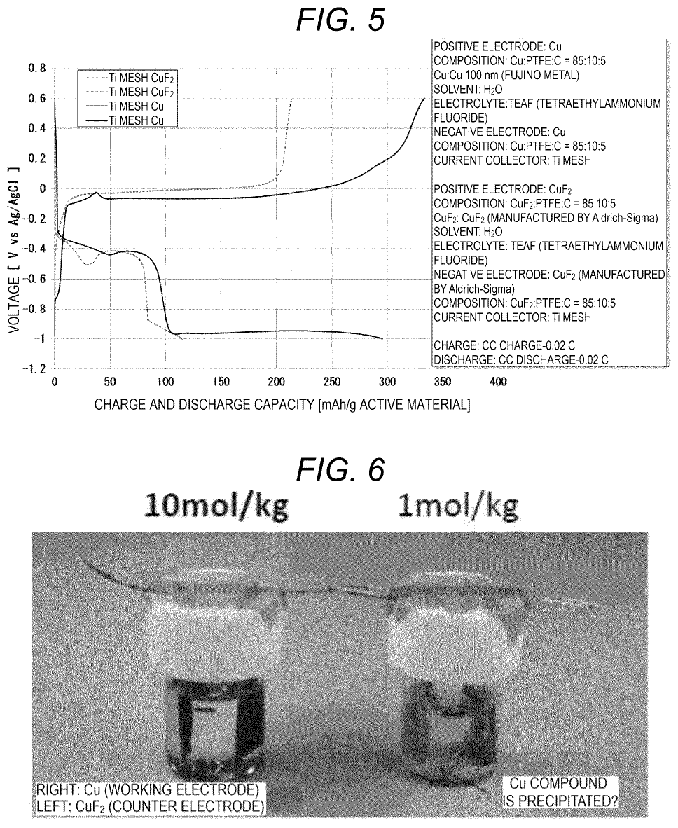

The result is shown in FIG. 5. As a result, when Cu was used as the positive electrode active material and the negative electrode active material, a charge capacity was 330 mAh/g and a discharge capacity was 290 mAh/g, and when CuF₂ was used as the positive electrode active material and the negative electrode active material, the charge capacity was 210 mAh/g and the discharge capacity was 120 mAh/g.

In addition, FIG. 6 shows an overview of the three-electrode electrolytic cell produced by the method in Production Example 1 after performing two cycles of the charge and discharge test using the aqueous solutions obtained in Example 1 and Comparative Example 1. In the charge and discharge test at this time, Cu was used as the working electrode (positive electrode), CuF₂ was used as the counter electrode (negative electrode), and the charge and discharge conditions were as described above. As a result, a precipitate was not observed even when the charge and discharge test was performed in Example 1, whereas a precipitate considered to be a copper compound was observed in Comparative Example 1.

1. A catalytic solution for a halide ion battery, which is an aqueous solution containing a quaternary ammonium halide salt or a hydrate thereof at 9.0 mol/kg to 11.0 mol/kg.

2. The catalytic solution for a halide ion battery according to claim 1, wherein the quaternary alkylammonium halide salt or the hydrate thereof contained in the aqueous solution is only one kind.

3. The catalytic solution for a halide ion battery according to claim 1, wherein the quaternary ammonium halide salt or the hydrate thereof is a quaternary ammonium fluoride salt or a hydrate thereof.

4. The catalytic solution for a halide ion battery according to claim 1, which is an electrolytic solution for a fluoride ion battery.

5. A halide ion battery comprising:
the catalytic solution for a halide ion battery according to claim 1.

6. The halide ion battery according to claim 5, which is a fluoride ion battery.

7. A method for producing the catalytic solution for a halide ion battery according to claim 1, comprising:
a step of dropping water to the quaternary ammonium halide salt or the hydrate thereof, wherein
an amount of the water dropped is 13 to 30 parts by mass with respect to 100 parts by mass of the quaternary ammonium halide salt or the hydrate thereof.
